(19) United States
(12) Patent Application Publication
(10) Pub. No.: US 2015/0227642 A1
(43) Pub. Date: Aug. 13, 2015

(54) METHOD AND DEVICE FOR COMPOSING THREE-DIMENSIONAL MODEL

(71) Applicants: XYZprinting, Inc., New Taipei City (TW); Kinpo Electronics, Inc., New Taipei City (TW); Cal-Comp Electronics & Communications Company Limited, New Taipei City (TW)

(72) Inventors: Yu-Chuan Chang, New Taipei City (TW); Chien-Hung Tung, New Taipei City (TW)

(21) Appl. No.: 14/322,928

(22) Filed: Jul. 3, 2014

(30) Foreign Application Priority Data
Feb. 11, 2014 (TW) 103104422

(51) Int. Cl. G06F 17/50; G06F 17/10

(52) U.S. Cl. CPC G06F 17/50; G06F 17/10

(57) ABSTRACT

A method and a device for composing three-dimension model are provided, and the method includes following steps. A base model is set. At least one symbol model is selected from a candidate database according to a symbol string. The symbol string includes the symbols arranged in sequence, and the at least one symbol is respectively associated with the at least one symbol model. The base model and the symbol models are analyzed so as to obtain space location information of the symbol models relative to the base model. The symbol models are composed with the base model according to the space location information so as to build up a three-dimension model associated to an object.

### CROSS-REFERENCE TO RELATED APPLICATION

This application claims the priority benefit of Taiwan application serial no. 103104422, filed on Feb. 11, 2014. The entirety of the above-mentioned patent application is hereby incorporated by reference herein and made a part of this specification.

### BACKGROUND

1. Technical Field

The technical field relates to a method for establishing three-dimensional (3D) model. Particularly, the disclosure relates to a method and a device for composing 3D model.

2. Related Art

Along with progress of computer-aided manufacturing (CAM), manufacturing industry has developed a three-dimensional (3D) printing technology, by which an original design conception can be quickly manufactured. The 3D printing technology is actually a general designation of a series of rapid prototyping (RP) techniques, and a basic principle thereof is additive manufacturing, where a RP machine is used to form sectional shapes of a workpiece in an X-Y plane through scanning, and intermittently shift by a layer thickness along a Z-axis, so as to form a 3D object. The 3D printing technology is not limited to any geometric shape, and the more complex the workpiece is, the more excellence the RP technology is demonstrated. The 3D printing technology can greatly save manpower and a processing time, and under a demand of the shortest time, a digital 3D model designed by software of 3D computer-aided design (CAD) can be truly presented as a physical part, which is not only touchable, a user can also actually feel a geometric curve of the physical part.

Generally, in a 3D printing device that produces 3D objects by using the aforementioned RP technique, a 3D model graphic is generally read to construct a 3D object associated with the digital 3D model. Therefore, if a user wants to embed a name or other text symbols on the 3D object, the user has to manually design and draw a digital 3D model of the embedded text during a process of establishing the digital 3D model by using computer software, which is not only time-costing and labor-consuming, but may also cause many unnecessary inconvenience to the user.

### SUMMARY

One of the exemplary embodiments is directed to a method and a device for composing 3D model, by which symbol models are quickly and automatically composed with a base model, so as to generate a 3D model of a 3D object embedded with a text symbol.

One of the exemplary embodiments provides a method for composing 3D model, which is adapted to an electronic device, and the method for composing 3D model includes following steps. A base model is set. At least one symbol model is selected from a candidate database according to a symbol string. The symbol string includes at least one symbol arranged in sequence, and the at least one symbol is respectively associated with the at least one symbol model. The base model and the symbol models are analyzed so as to obtain space location information of the symbol models relative to the base model. The symbol models are composed with the base model according to the space location information so as to build up a three-dimension (3D) model associated with an object.

According to another aspect, one of the exemplary embodiments provides a 3D model composing device including a storage unit and a processing unit. The storage unit records a plurality of modules and stores a candidate database. The processing unit is coupled to the storage unit, and accesses and executes the modules recorded in the storage unit, where the modules include a setting module, a selection module, an analysis module and a build-up module. The setting module sets a base model. The selection module selects at least one symbol model from the candidate database according to a symbol string, and the at least one symbol is respectively associated with the at least one symbol model. The symbol string includes at least one symbol arranged in sequence. The analysis module analyzes the base model and the symbol models to obtain space location information of the symbol models relative to the base model. The build-up module composes the symbol models with the base model according to the space location information, so as to build up a 3D model associated with an object.

According to the above descriptions, in an embodiment, when the 3D model composing device receives the symbol string selected by the user, the 3D model composing device automatically analyses the base model and the corresponding symbol models to obtain the space location information of the symbol models relative to the base model. Moreover, the 3D model composing device composes the symbol models with the base model according to the space location information, so as to build up a 3D model associated to an object. In this way, the user can quickly obtain the composed 3D model through simple operation steps, and a 3D printing device can print the object embedded with symbols according to the composed 3D model, so as to greatly save a time required for manual design and drawing.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the exemplary embodiments, and are incorporated in and constitute a part of this specification. The drawings illustrate exemplary embodiments and, together with the description, serve to explain the principles of the exemplary embodiments.

FIG. 1 is a block diagram of a three-dimensional (3D) model composing device according to an exemplary embodiment.

FIG. 2 is a flowchart illustrating a method for composing a 3D model according to an exemplary embodiment.

FIG. 3A and FIG. 3B are schematic diagrams of composing a 3D model according to an exemplary embodiment.

FIG. 4A and FIG. 4B are schematic diagrams of composing a 3D model according to an exemplary embodiment.

FIG. 4C and FIG. 4D are schematic diagrams of composing a 3D model according to an exemplary embodiment.

### DETAILED DESCRIPTION OF DISCLOSED EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

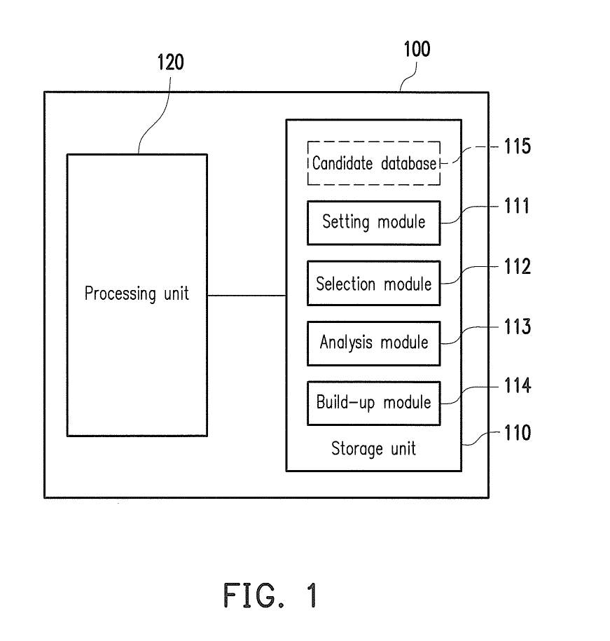

FIG. 1 is a block diagram of a three-dimensional (3D) model composing device according to an exemplary embodiment. Referring to FIG. 1, the 3D model composing device 100 is an electronic apparatus having a computation function, for example, computer device such as a notebook computer, a tablet computer or a desktop computer, etc., and the type of the 3D model composing device 100 is not limited by the disclosure. In the present embodiment, the 3D model composing device 100 can edit and process 3D model information of an object and transmit the 3D model information to a 3D printing device (not shown), and the 3D printing device can print a 3D object according to the 3D model information.

In the present exemplary embodiment, the 3D model composing device 100 includes a storage unit 110 and a processing unit 120. The storage unit 110 is, for example, a fixed or movable random access memory (RAM) of any type, a read-only memory (ROM), a flash memory, a hard disk or other similar devices or a combination of the above devices, which is used for recording a plurality of modules executed by the processing unit 120, and these modules can be loaded to the processing unit 120 to execute a function of composing 3D model.

The processing unit 120 is, for example, a central processing unit (CPU), or other programmable general-purpose or special-purpose microprocessor, a digital signal processor (DSP), a programmable controller, an application specific integrated circuit (ASIC), a programmable logic device (PLD) or other similar device or a combination of the devices. The processing unit 120 is coupled to the storage unit 110, and can access and executes the modules stored in the storage unit 110, so as to execute the function of composing a 3D model.

The said modules include a setting module 111, a selection module 112, an analysis module 113 and a build-up module 114. The modules are, for example, computer programs or instructions, and can be loaded to the processing unit 120 to execute the function of composing a 3D model. An embodiment is provided below to describe detailed steps of the method for composing 3D model executed by the 3D model composing device 100.

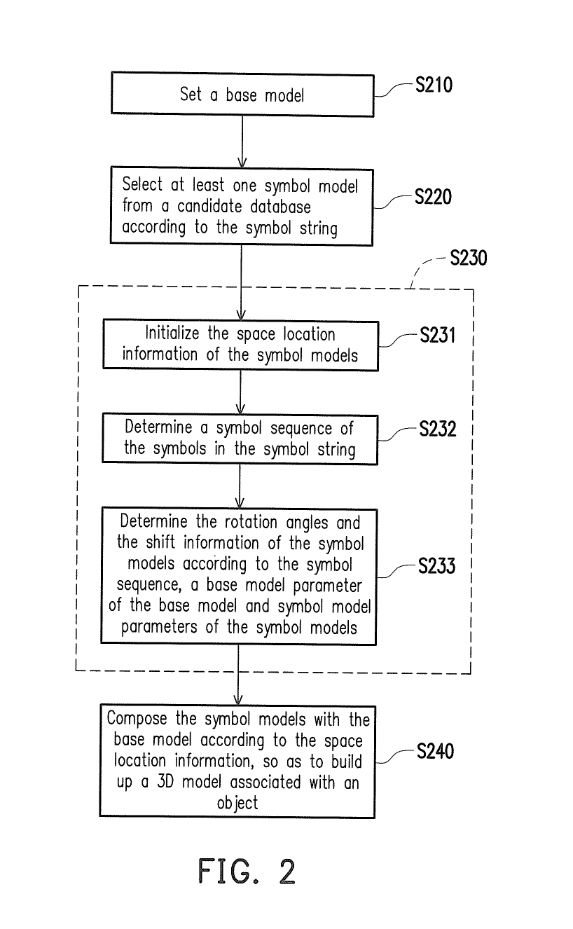

FIG. 2 is a flowchart illustrating a method for composing a 3D model according to an exemplary embodiment. Referring to FIG. 2, first, in step S210, the setting module 111 sets a base model. The base model can be a basic 3D model stored in an object database, for example, a basic 3D model corresponding to a basic prototype such as a sphere, a cube, a ring, a cylinder, a cone, etc. Moreover, the base model can also be a model created by using model editing software (for example, Maya or 3DMax), or can be a 3D model obtained by scanning object according to a 3D scanning technique, and the method of creating or obtaining the base model is not limited by the disclosure.

Moreover, in order to embed a customized text or symbol on a base object, the 3D model composing device 100 receives a symbol string including text or symbol. For example, the 3D model composing device 100 may provide an input interface to facilitate the user inputting the symbol string to be embedded. In this way, if the user wants to embed a text of for example, “Alex” on the base object, the user can input a word string “Alex” to the input interface provided by the 3D model composing device 100. Namely, the symbol string includes at least one symbol arranged in sequence, and a type of the symbol includes one of a number symbol, an alphabet symbol, a punctuation symbol and a combination thereof, which is not limited by the disclosure.

In step S220, the selection module 112 selects at least one symbol model corresponding to at least one symbol from a candidate database according to the symbol string. In the present embodiment, the symbol model of each symbol has been created and stored in the candidate database 115. It should be noticed that a shape and an appearance of the symbol model can be designed according to an actual application, and is not limited by the disclosure. For example, the symbol model of each symbol can be a square panel-like 3D model with a fixed size or can be a round panel-like 3D model. In detail, in an embodiment, the 3D models corresponding to uppercase letters “A” to “Z” and lowercase letters “a” to “z” have been created in the candidate database 115, and these 3D models are, for example, panel-like 3D models with both length and width of 2 cm.

Therefore, after the 3D model composing device 100 obtains the symbol string, the selection module 112 selects a symbol model corresponding to each of the symbols in the symbol string from the candidate database. For example, it is assumed that the symbol string is the word string “Alex”, the selection module 112 selects the symbol models respectively corresponding to the word “A”, the word “1”, the word “e” and the word “x” from the candidate database 115.

In step S230, the analysis module 113 analyzes the base model and the symbol models to obtain space location information of the symbol models relative to the base model. According to the above description, it is known that the base mode and the symbol models are all 3D models that have been built up, so that the analysis module 113 can learn various model parameters of the base model and the symbol model. Moreover, the analysis module 113 can also learn space coordinate information of the base model and the symbol models relative to a 3D reference coordinate system. Therefore, the analysis module 113 can analyze the model parameters of the base model and the symbol models to determine how to embed the symbol models to the base model. In detail, in the present embodiment, the step 230 of analysing the model parameters to obtain space location information of the symbol models relative to the base model may include following three steps S231-S233.

First, in step S231, the analysis module 113 initializes the space location information of the symbol models, where the space location information includes rotation angles and shift information. In detail, the step of initialization can be regarded as a step of mapping an original coordinate position stored in the candidate database that corresponds to the symbol models to an initial position under the parameter coordinate system of the base model. Namely, all of the symbol models to be composed are placed to the initial position under the parameter coordinate system of the base model through space transformation. Meanwhile, a space rotation processing is not performed to the symbol models to be composed, so that all of the symbols on the symbol models to be composed face to a specific direction in the parameter coordinate system of the base model.

After the space location information of the symbol models is initialized, in step S232, the analysis module 113 determines a symbol sequence of the symbols in the symbol string. Then, in step S233, the analysis module 113 determines the rotation angles and the shift information of the symbol models according to the symbol sequence, a base model parameter of the base model and symbol model parameters of the symbol models. In detail, according to an arranging sequence of the symbols in the symbol string, each of the symbols is embedded o different relative positions. Therefore, the analysis module 113 calculates corresponding shift information and rotation angles for the symbol models selected by the selection module 112. Moreover, the base model parameter of the base model and the symbol model parameters of the symbol models are all factors that determine the rotation angles and the shift information. For example, in order to ensure an object surface of the embedded symbol presenting a smooth and natural visual effect, the rotation angel of each symbol model is determined according to a surface curvature of the symbol model. Detailed analysis and calculation method are described in following paragraphs.

After the analysis module 113 determines the rotation angles and the shift information of the symbol models, in step S240, the build-up module 114 composes the symbol models with the base model according to the space location information, so as to build up a 3D model associated with an object. Namely, the build-up module 114 rotates each of the symbol models according to the rotation angle of the space location information, and moves each of the symbol models to a specific position under the parameter coordinate system of the base model according to the shift information of the space location information. In this way, since the base model and the symbol models all belong to the same reference coordinate system, the build-up module 114 can compose the rotated and shifted symbol models with the base model.

In order to further describe how the analysis module 113 determines the rotation angles and the shift information of the symbol models according to the symbol sequence, the base model parameter of the base model and the symbol model parameters of the symbol models, the base model is assumed to be a cylinder and a prism for descriptions.

When the base model is a cylinder, in order to align all of the symbol models with an arc surface of a cylinder base, the rotation angles of the symbol models are different. Further, the analysis module 113 determines a unit rotation angle of the symbol module according to a radius and a size of the symbol model. Then, the analysis module 113 determines the rotation angle of the symbol model rotated along a first axial direction according to the symbol sequence and the unit rotation angle of each symbol. Moreover, the analysis module 113 further determines a reference shift amount of the symbol model according to a radius of the cylinder and the unit rotation angle, and determines a first shift amount of the symbol model along a second axial direction and a second shift amount of the symbol model along a third axial direction according to the reference shift amount and the rotation angle.

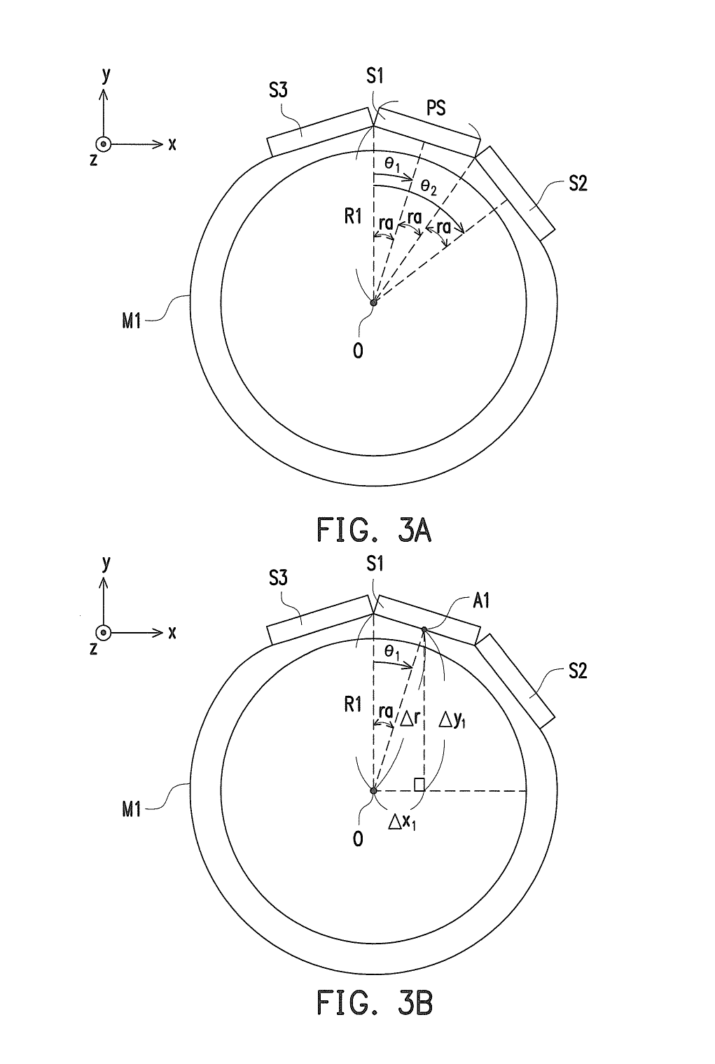

For example, FIG. 3A and FIG. 3B are schematic diagrams of composing a 3D model according to an exemplary embodiment. Referring to FIG. 3A, in the present exemplary embodiment, it is assumed that the base model is built up under an XYZ orthogonal coordinate system, where the first axial direction is a z-axis direction, the second axial direction is an x-axis direction and the third axial direction is a y-axis direction. Moreover, as shown in FIG. 3A, the base model is a cylinder M1, and the symbol models S1-S3 are panel-like 3D models, where R1 represents a cylindrical radius of the cylinder M1, PS represents a length-width dimension of the symbol models S1-S3. It should be noticed that in the present embodiment, the length-width dimensions of the symbol models S1-S3 are the same, though the disclosure is not limited thereto, and in other embodiments, the length-width dimensions of the symbol models S1-S3 can be different. Moreover, in an actual application and usage situation, the length-width dimensions PS of the symbol models S1-S3 can be adjusted through different coefficient factors, for example, the coefficient factor is, for example, the golden ratio (φ=0.618).

Therefore, the analysis module 113 cam determine the unit rotation angles of the symbol models S1-S3 according to the length-width dimensions PS of the symbol models S1-S3 and the cylindrical radius R1 of the cylinder M1. Further, in the exemplary embodiment of FIG. 3A, the unit rotation angle ra can be obtained according to a following equation (1).

$$ra = {sin}^{- 1} \frac{( \frac{ps}{2} )}{R} \qquad equation ( 1 )$$

Then, the analysis module 113 determines the rotation angles of the symbol models rotated along the first axial direction according to the symbol sequence of each symbol and the unit rotation angles. According to the above descriptions, since the position of each symbol model is different, the respective rotation angles of the symbol models S1-S3 are also different. For example, in the exemplary embodiment of FIG. 3A, θ₁ represents the rotation angle of the symbol model S1, which is equal to the unit rotation angle ra, θ₂ represents the rotation angle of the symbol model S2, and is equal to triple of the unit rotation angle ra. Therefore, the symbol model S1 is rotated by the rotation angle θ₁ along the z-axis direction serving as a rotation axis, and the symbol model S2 is rotated by the rotation angle θ₂ along the z-axis direction. In detail, the analysis module 113 generates the rotation angle of each symbol model according to following program codes (L1):

if (p%/2=0)//p is even

θᵢ=ra*(((i−(p/2))+0.5*2);

else

θᵢ=ra*((i−(p/2))*2); (L1)

Where, in the program codes (L1), p is a number of the symbols in the symbol string, i is the symbol sequence of the symbol model, ra is the unit rotation angle, and θᵢ is the rotation angle of each symbol model. According to the above descriptions, the analysis module 113 can calculate the rotation angle of each symbol model along the z-axis direction according to the symbol sequence of the symbol model, the symbol model parameter and the base model parameter.

Then, in order to obtain the shift information of each symbol model, the analysis module 113 determines a reference shift amount of the symbol model according to the cylindrical radius R1 of the cylinder M1 and the unit rotation angle ra. Referring to FIG. 3B, in the exemplary embodiment of FIG. 3B, Ar represents the reference shift amount and can be obtained according to a following equation (2):

Δr=R1*cos(ra) equation (2)

Therefore, the analysis module 113 determines a first shift amount of the symbol model along the second axial direction and a second shift amount of the symbol model along the third axial direction according to the reference shift amount Ar and the rotation angle. Taking the symbol model S1 as an example, the analysis module 113 determines a first shift amount Δx₁ of the symbol model S1 along the x-axis direction and a second shift amount Δy₁ of the symbol model S1 along the y-axis direction according to the reference shift amount Δr and the rotation angle θ₁. The first shift amount of each symbol model along the x-axis direction and the second shift amount of each symbol model along the y-axis direction can be calculated according to following equations (3) and (4):

Δxᵢ=Δr*sin(θᵢ) equation (3)

Δyᵢ=Δr*cos(θ₁) tm equation (4)

According to the aforementioned calculation methods of the rotation angle and the shift information, the analysis module 113 can calculate the space location information of each of the symbol models S1-S3 relative to the cylinder M1 according to the cylindrical radius of the cylinder M1, the length-width dimensions of the symbol models S1-S3 and the symbol sequence. Therefore, the build-up module 114 can compose the symbol models S1-S3 with the cylinder M1 according to the space location information of each of the symbol models S1-S3 relative to the cylinder M1. It should be noticed that in the present embodiment, a height of each of the symbol models disposed on the cylinder M1 is a predetermined height, though the disclosure is not limited thereto. As shown in FIG. 3B, taking the symbol model S1 as an example, according to the first shift amount Δx₁ and the second shift amount Δy₁ of the symbol model S1 relative to a reference coordinate point O, the build-up module 114 can move the symbol model S1 to a coordinate point A1. Then, the build-up module 114 rotates the symbol model S1 by the rotation angle θ₁, so as to align the symbol model S1 to the surface of the cylinder M1 smoothly.

Moreover, the situation that the base model is a prism is described below. It should be noticed that in the example that the base model is implemented by a prism, since each surface of the prism has a fixed width, if the number of the symbols in the symbol string is excessive, a phenomenon that the single surface of the prism cannot accommodate the complete symbol string is occurred. Therefore, in an embodiment, the analysis module 133 compares the width of the single surface of the prism with a width required for embedding the symbol string, and if the single surface of the prism cannot accommodate all of the symbols to be embedded, the analysis module 133 changes an arranging direction of the symbol models on the base model.

In detail, the analysis module 113 determines a string length of the symbol string according to the number of the symbols in the symbol string and the dimensions of the symbol models. If the string length is not greater than a single surface width of the prism, the analysis module 113 determines the first shift amount of the symbol models along the first axial direction according to the dimensions of the symbol models and the symbol sequence. If the string length is greater than the single surface width of the prism, the analysis module 113 determines a second shift amount of the symbol models along the second axial direction according to the dimensions of the symbol models and the symbol sequence. Moreover, in an embodiment, if the string length is greater than the single surface width of the prism, besides that the analysis module 113 arranges the symbol models along another direction, the analysis module further determines the rotation angles of the symbol models along the third axial direction according to a presetting.

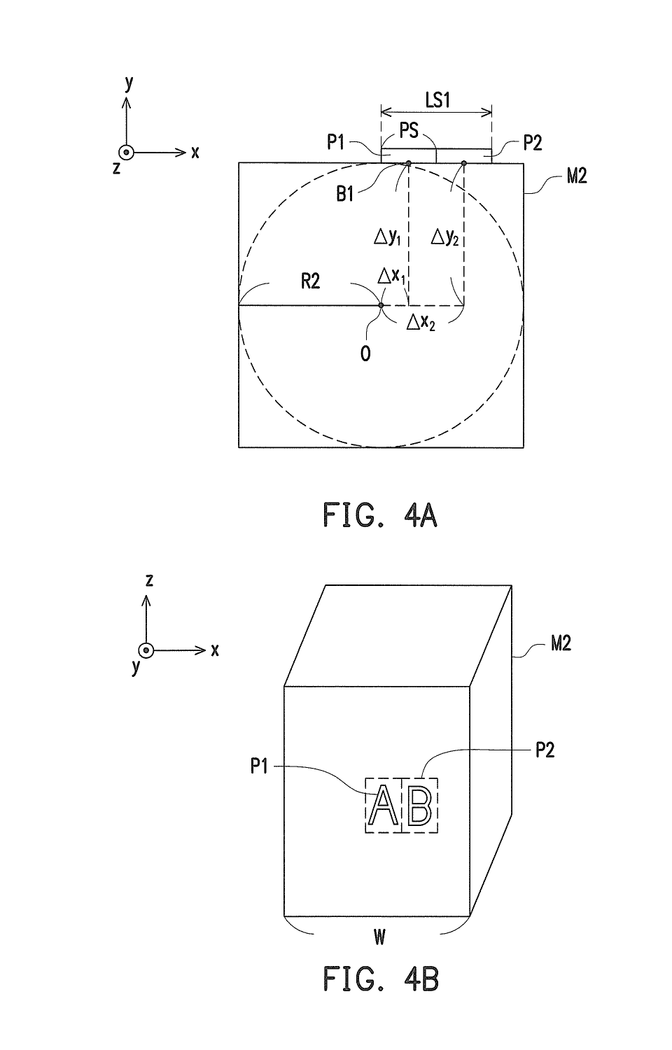

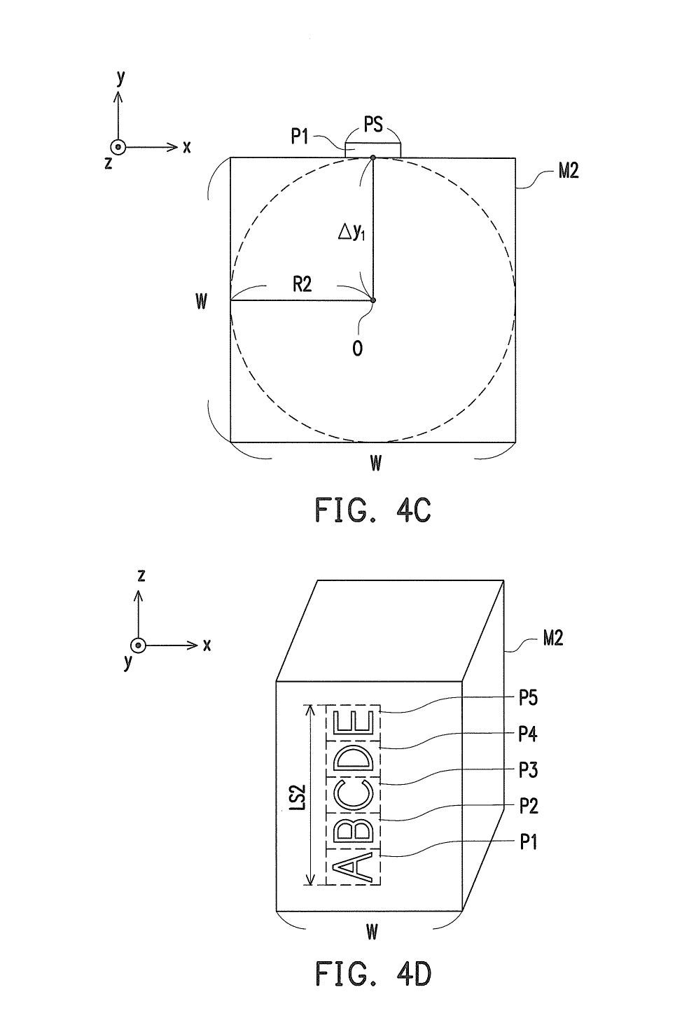

For example, FIG. 4A and FIG. 4B are schematic diagrams of composing a 3D model according to an exemplary embodiment. Referring to FIG. 4A, in the present exemplary embodiment, it is assumed that the base model is built up under the XYZ orthogonal coordinate system, where the first axial direction is the x-axis direction, the second axial direction is the z-axis direction and the third axial direction is the y-axis direction. In the present exemplary embodiment, the base mode parameters of the prism M2 include a surface number F of the prism and a radius R2 of an inscribed circle of the prism. Moreover, as shown in FIG. 4A, regarding a regular quadrangular prism model, the surface number F of the prism is four, and the single surface width W is twice of the radius R2 of the inscribed circuit. Moreover, the symbol models P1 and P2 are panel-like 3D models, and symbol model parameter includes dimensions PS of the symbol models P1 and P2.

In the exemplary embodiment of FIG. 4A and FIG. 4B, it is assumed that the symbol string is a word string “AB”. The analysis module 113 analyzes that the word string “AB” has a symbol “A” and a symbol “B”, and the symbol number of the word string “AB” is two. The symbol “A” corresponds to the symbol model P1, and the symbol “B” corresponds to the symbol model P2. Referring to FIG. 4A, the analysis module 113 determines a string length LS1 of the symbol string according to the symbol number and the dimensions PS of the symbol models P1 and P2, and the string length LS1 represents the minimum width required for embedding the symbol “A” and the symbol “B”.

As shown in FIG. 4A, since the string length LS1 is shorter than the single surface width W of the prism M2, the analysis module 113 determine shift amounts Δx₁ and Δx₂ of the symbol models P1 and P2 along the x-axis direction according to the dimensions PS and the symbol sequence of the symbol models P1 and P2. In detail, the analysis module 113 calculates the first shift amount of each symbol model along the x-axis direction according to following program codes (L2):

if (p%/2=0)//p is even

Δxᵢ=ps*sx*(((i−(p/2))+0.5*2);

else

Δxᵢ=ps*sx*((i−(p/2))*2); (L2)

Where, in the program codes (L2), p is a number of the symbols in the symbol string, i is the symbol sequence of the symbol model, ps is a dimension of the symbol model, sx is a coefficient factor used for adjusting the dimension of the symbol model, and Δx₁ is the first shift amount of each symbol model along the first axial direction. In conclusion, in the example that the base model is implemented by a prism, when the string length is smaller than the single surface width, the analysis module 113 can calculate the first shift amount of each symbol module along the first axial direction according to the symbol sequence of the symbol models, the symbol model parameters and the base model parameter.

Compared to the base model of the cylinder, since the surface of the prism is not an arc plane, the analysis module 113 is unnecessary to rotate the symbol models P1 and P2 along the z-axis, and a shift amount of each of the symbol models P1 and P2 along the y-direction is the same, i.e. the shift amount Δy₁ is equal to the shift amount Δy₂. Moreover, in the present embodiment, a height of each of the symbol models P1 and P2 placed on the prism M2 is a predetermined height, though the disclosure is not limited thereto. Therefore, taking the symbol model P1 as an example, according to the first shift amount Δx₁, the shift amount Δy₁ and the predetermined height of the symbol model P1, the build-up module 114 can move the symbol model P1 to a coordinate point B1, so as to compose the symbol model P1 with the prism M2 to produce a composed 3D model. As shown in FIG. 4B, the symbol models P1 and P2 are arranged on the prism M2 along the x-axis direction.

On the other hand, FIG. 4C and FIG. 4D are schematic diagrams of composing a 3D model according to an exemplary embodiment. Referring to FIG. 4C, in the present exemplary embodiment, it is assumed that the base model is built up under the XYZ orthogonal coordinate system, where the first axial direction is the x-axis direction, the second axial direction is the z-axis direction and the third axial direction is the y-axis direction. In the present exemplary embodiment, the base mode parameters of the prism M2 include the surface number F of the prism and the radius R2 of an inscribed circle of the prism. Moreover, as shown in FIG. 4C, regarding a regular quadrangular prism model, the surface number F of the prism is four, and the single surface width W is twice of the radius R2 of the inscribed circuit. Moreover, the symbol models P1 and P2 are panel-like 3D models, and symbol model parameter includes dimensions PS of the symbol models P1 and P2.

In the exemplary embodiment of FIG. 4C and FIG. 4D, it is assumed that the symbol string is a word string “ABCDE”. The analysis module 113 analyzes that the word string “ABCDE” has a word “A”, a word “B”, a word “C”, a word “D” and a word “E”, and the symbol number of the word string “ABCDE” is five. The word “A” corresponds to the symbol model P1, the word “B” corresponds to the symbol model P2, the word “C” corresponds to the symbol model P3, the word “D” corresponds to the symbol model P4, and the word “E” corresponds to the symbol model P5. In the present exemplary embodiment, the analysis module 113 determines a string length LS2 according to the symbol number of the word string “ABCDE” and the dimensions PS of the symbol models P1-P5, and the string length LS2 represents the minimum width required for embedding the word “A”, the word “B”, the word “C”, the word “D” and the word “E”.

In the example of FIG. 4C and FIG. 4D, the analysis module 113 determines that the string length LS2 is greater than the single surface width W of the prism M2. Therefore, the analysis module 113 determine second shift amounts Δz₁-Δz₅ of the symbol models P1-P5 along the z-axis direction according to the dimensions PS of the symbol models P1 and P2 and the symbol sequence. Namely, when the string length LS2 is greater than the single surface width W of the prism M2, compared to the example shown in FIG. 4A and FIG. 4B, the analysis module 113 does not calculate the first shift amounts of the symbol models along the x-axis direction, but calculates the second shift amounts of the symbol models along the z-axis direction. For example, the analysis module 113 calculates the second shift amount of each symbol model along the z-axis direction according to following program codes (L3):

if(p%2=0)//p is even

Δzᵢ=ps*sx*(((i−(p/2))+0.5)*2);

else

Δzᵢ=ps*sx*((i−(p/2))*2); (L3)

Where, in the program codes (L3), p is a number of the symbols in the symbol string, i is the symbol sequence, ps is a dimension of the symbol model, sx is a coefficient factor used for adjusting the dimension of the symbol model, and Δzᵢ is the second shift amount of each symbol model along the second axial direction.

In conclusion, in the example that the base model is implemented by a prism, when the string length is greater than the single surface width, the analysis module 113 can calculate the second shift amount of each symbol module along the second axial direction according to the symbol sequence of the symbol models, the symbol model parameters and the base model parameter. In brief, when the analysis module 113 determines that the string length is greater than the single surface width, the analysis module 113 changes the arranging direction of the symbol models. As shown in FIG. 4D, the symbol models P1-P5 are arranged on the prism M2 along the z-axis direction. It should be noticed that when the analysis module 113 changes the arranging direction of the symbol models, the analysis module 113 further determines rotation angles of the symbol models along the y-axis direction according to presetting. In the example of FIG. 4D, the analysis module 113 rotates the symbol models P1-P5 by 90 degrees along the y-axis direction according to the presetting, such that the symbol models arranged along the arranging direction may have an optimal text presentation.

In summary, in an embodiment of the disclosure, the 3D model composing device analyzes and calculates the base model parameter of the base model and the symbol model parameters of the symbol models to obtain the space location information of the symbol models relative to the base model. Therefore, the 3D model composing device disposes the symbol models at a specific space location according to the space location information, so as to automatically compose the 3D model of the embedded symbol models. In this way, the user can compose the symbol models to the known base model to produce a 3D model associated to an object through simple operation steps, so as to greatly save a time required for manually designing and drawing the 3D model. Namely, when the user wants to embed text or symbols on the object to be printed, the method for composing 3D model of the disclosure can be used to greatly reduce labor and time cost.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A method for composing three-dimensional model, adapted to an electronic device to build up a three-dimensional model associated to an object by using a candidate database, the method for composing three-dimensional model comprising:
setting a base model;
selecting at least one symbol model from the candidate database according to a symbol string, wherein the symbol string comprises at least one symbol arranged in sequence, and the at least one symbol is respectively associated with the at least one symbol model;
analyzing the base model and the at least one symbol model, so as to obtain space location information of the at least one symbol model relative to the base model; and
composing the at least one symbol model with the base model according to the space location information, so as to build up the three-dimension model associated with the object.

2. The method for composing three-dimensional model as claimed in claim 1, wherein the step of analyzing the base model and the at least one symbol model, so as to obtain the space location information of the at least one symbol model relative to the base model comprises:
initializing the space location information of the at least one symbol model, wherein the space location information comprises a rotation angle and shift information;
determining a symbol sequence of the at least one symbol in the symbol string; and
determining the rotation angle and the shift information of the at least one symbol model according to the symbol sequence, a base model parameter of the base model and a symbol model parameter of the at least one symbol model.

3. The method for composing three-dimensional model as claimed in claim 2, wherein the base model is a cylinder, and the step of determining the rotation angle and the shift information of the at least one symbol model according to the symbol sequence, the base model parameter of the base model and the symbol model parameter of the at least one symbol model comprises:
determining a unit rotation angle of the at least one symbol model according to a radius of the cylinder and a dimension of the at least one symbol model; and
determining the rotation angle of the at least one symbol model rotated along a first axial direction serving as a rotation axis according to the symbol sequence of the symbols and the unit rotation angle.

4. The method for composing three-dimensional model as claimed in claim 3, wherein the step of determining the rotation angle and the shift info nation of the at least one symbol model according to the symbol sequence, the base model parameter of the base model and the symbol model parameter of the at least one symbol model further comprises:
determining a reference shift amount of the at least one symbol model according to the radius of the cylinder and the unit rotation angle; and
determining a first shift amount of the at least one symbol model along a second axial direction and a second shift amount of the at least one symbol model along a third axial direction according to the reference shift amount and the rotation angle.

5. The method for composing three-dimensional model as claimed in claim 2, wherein the base model is a prism, and the step of determining the rotation angle and the shift information of the at least one symbol model according to the symbol sequence, the base model parameter of the base model and the symbol model parameter of the at least one symbol model comprises:
determining a string length of the symbol string according to a symbol number of the at least one symbol in the symbol string and a dimension of the at least one symbol model
determining a first shift amount of the at least one symbol model along a first axial direction according to a dimension of the at least one symbol model and the symbol sequence if the string length is not greater than a single surface width of the prism; and
determining a second shift amount of the at least one symbol model along a second axial direction according to the dimension of the at least one symbol model and the symbol sequence if the string length is greater than the single surface width of the prism.

6. The method for composing three-dimensional model as claimed in claim 5, wherein if the string length is greater than the single surface width of the prism, the step of determining a shift amount of the at least one symbol model along the first axial direction according to the dimension of the at least one symbol model and the symbol sequence further comprising:
determining the rotation angle of the at least one symbol model rotated along a third axial direction serving as a rotation axis according to a presetting.

7. The method for composing three-dimensional model as claimed in claim 1, wherein a type of the at least one symbol comprises one of a number symbol, an alphabet symbol and a punctuation symbol and a combination thereof.

8. A three-dimensional model composing device, adapted to build up a three-dimensional model associated with an object, comprising:
a storage unit, recording a plurality of modules, and storing a candidate database; and
a processing unit, coupled to the storage unit, and accessing and executing the modules recorded in the storage unit, wherein the modules comprises:
a setting module, setting a base model;
a selection module, selecting at least one symbol model from the candidate database according to a symbol string, wherein the symbol string comprises at least one symbol arranged in sequence, and the at least one symbol is respectively associated with the at least one symbol model;
an analysis module, analyzing the base model and the symbol models to obtain space location information of the at least one symbol model relative to the base model; and
a build-up module, composing the at least one symbol model with the base model according to the space location information, so as to build up the three-dimensional model associated with the object.

9. The three-dimensional model composing device as claimed in claim 8, wherein the analysis model initializes the space location information of the at least one symbol model, the space location information comprises a rotation angle and shift information, the analysis module determines a symbol sequence of the at least one symbol in the symbol string, and the analysis module determines the rotation angle and the shift information of the at least one symbol model according to the symbol sequence, a base model parameter of the base model and a symbol model parameter of the at least one symbol model.

10. The three-dimensional model composing device as claimed in claim 9, wherein the base model is a cylinder, the analysis module determines a unit rotation angle of the at least one symbol model according to a radius of the cylinder and a dimension of the at least one symbol model, and the analysis module determines the rotation angle of the at least one symbol model rotated along a first axial direction serving as a rotation axis according to the symbol sequence of the symbols and the unit rotation angle.

11. The three-dimensional model composing device as claimed in claim 10, wherein the analysis module determines a reference shift amount of the at least one symbol model according to the radius of the cylinder and the unit rotation angle, and the analysis module determines a first shift amount of the at least one symbol model along a second axial direction and a second shift amount of the at least one symbol model along a third axial direction according to the reference shift amount and the rotation angle.

12. The three-dimensional model composing device as claimed in claim 9, wherein the base model is a prism, the analysis module determines a string length of the symbol string according to a symbol number of the at least one symbol in the symbol string and a dimension of the at least one symbol model,
wherein if the string length is not greater than a single surface width of the prism, the analysis module determines a first shift amount of the at least one symbol model along a first axial direction according to a dimension of the at least one symbol model and the symbol sequence,
if the string length is greater than the single surface width of the prism, the analysis module determines a second shift amount of the at least one symbol model along a second axial direction according to the dimension of the at least one symbol model and the symbol sequence.

13. The three-dimensional model composing device as claimed in claim 12, wherein if the string length is greater than the single surface width of the prism, the analysis module determines the rotation angle of the at least one symbol model rotated along a third axial direction serving as a rotation axis according to a presetting.

14. The three-dimensional model composing device as claimed in claim 8, wherein a type of the at least one symbol comprises one of a number symbol, an alphabet symbol and a punctuation symbol and a combination thereof.
